(19) United States
(12) Patent Application Publication
(10) Pub. No.: US 2016/0142973 A1
(43) Pub. Date: May 19, 2016

(54) METHOD AND APPARATUS FOR SWITCHING OFF CELL FOR ENERGY SAVING IN WIRELESS COMMUNICATION SYSTEM

(71) Applicant: LG ELECTRONICS INC., Seoul (KR)

(72) Inventors: Insun Lee, Seoul (KR); Daewook Byun, Seoul (KR); Jian Xu, Seoul (KR); Kyungmin Park, Seoul (KR)

(73) Assignee: LG ELECTRONICS INC., Seoul (KR)

(21) Appl. No.: 14/896,801

(22) PCT Filed: Aug. 8, 2014
(86) PCT No.: PCT/KR2014/007384

§ 371 Date: Dec. 8, 2015

Related U.S. Application Data
(60) Provisional application No. 61/863,917, filed on Aug. 9, 2013.

(51) Int. Cl. H04W 52/02; H04W 36/38; H04W 36/00; H04W 36/30

(52) U.S. Cl. CPC H04W 52/0206; H04W 36/30; H04W 36/38; H04W 36/0083

(57) ABSTRACT

A method and apparatus for switching off a cell for energy saving in a wireless communication system is provided. A first eNodeB (eNB) transmits information on quality of services (QoS) of user equipments (UEs), connected to the first eNB, to a macro eNB, and receives a list of recommended cells for handover of all or a part of the UEs. Then the first eNB performs handover of all or the part of the UEs with a second eNB which manages a cell included in the list of recommended cells, and switches off a cell managed by the first eNB.

### BACKGROUND OF THE INVENTION

1. Field of the Invention

The present invention relates to wireless communications, and more particularly, to a method and apparatus for switching off a cell for energy saving in a wireless communication system.

2. Related Art

Universal mobile telecommunications system (UMTS) is a 3rd generation (3G) asynchronous mobile communication system operating in wideband code division multiple access (WCDMA) based on European systems, global system for mobile communications (GSM) and general packet radio services (GPRS). The long-term evolution (LTE) of UMTS is under discussion by the 3rd generation partnership project (3GPP) that standardized UMTS.

The 3GPP LTE is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

FIG. 1 shows LTE system architecture. The communication network is widely deployed to provide a variety of communication services such as voice over internet protocol (VoIP) through IMS and packet data.

Referring to FIG. 1, the LTE system architecture includes one or more user equipment (UE; 10), an evolved-UMTS terrestrial radio access network (E-UTRAN) and an evolved packet core (EPC). The UE 10 refers to a communication equipment carried by a user. The UE 10 may be fixed or mobile, and may be referred to as another terminology, such as a mobile station (MS), a user terminal (UT), a subscriber station (SS), a wireless device, etc.

The E-UTRAN includes one or more evolved node-B (eNB) 20, and a plurality of UEs may be located in one cell. The eNB 20 provides an end point of a control plane and a user plane to the UE 10. The eNB 20 is generally a fixed station that communicates with the UE 10 and may be referred to as another terminology, such as a base station (BS), a base transceiver system (BTS), an access point, etc. One eNB 20 may be deployed per cell. There are one or more cells within the coverage of the eNB 20. A single cell is configured to have one of bandwidths selected from 1.25, 2.5, 5, 10, and 20 MHz, etc., and provides downlink or uplink transmission services to several UEs. In this case, different cells can be configured to provide different bandwidths.

Hereinafter, a downlink (DL) denotes communication from the eNB 20 to the UE 10, and an uplink (UL) denotes communication from the UE 10 to the eNB 20. In the DL, a transmitter may be a part of the eNB 20, and a receiver may be a part of the UE 10. In the UL, the transmitter may be a part of the UE 10, and the receiver may be a part of the eNB 20.

The EPC includes a mobility management entity (MME) which is in charge of control plane functions, and a system architecture evolution (SAE) gateway (S-GW) which is in charge of user plane functions. The MME/S-GW 30 may be positioned at the end of the network and connected to an external network. The MME has UE access information or UE capability information, and such information may be primarily used in UE mobility management. The S-GW is a gateway of which an endpoint is an E-UTRAN. The MME/S-GW 30 provides an end point of a session and mobility management function for the UE 10. The EPC may further include a packet data network (PDN) gateway (PDN-GW). The PDN-GW is a gateway of which an endpoint is a PDN.

The MME provides various functions including non-access stratum (NAS) signaling to eNBs 20, NAS signaling security, access stratum (AS) security control, Inter core network (CN) node signaling for mobility between 3GPP access networks, idle mode UE reachability (including control and execution of paging retransmission), tracking area list management (for UE in idle and active mode), P-GW and S-GW selection, MME selection for handovers with MME change, serving GPRS support node (SGSN) selection for handovers to 2G or 3G 3GPP access networks, roaming, authentication, bearer management functions including dedicated bearer establishment, support for public warning system (PWS) (which includes earthquake and tsunami warning system (ETWS) and commercial mobile alert system (CMAS)) message transmission. The S-GW host provides assorted functions including per-user based packet filtering (by e.g., deep packet inspection), lawful interception, UE Internet protocol (IP) address allocation, transport level packet marking in the DL, UL and DL service level charging, gating and rate enforcement, DL rate enforcement based on APN-AMBR. For clarity MME/S-GW 30 will be referred to herein simply as a “gateway,” but it is understood that this entity includes both the MME and S-GW.

Interfaces for transmitting user traffic or control traffic may be used. The UE 10 and the eNB 20 are connected by means of a Uu interface. The eNBs 20 are interconnected by means of an X2 interface. Neighboring eNBs may have a meshed network structure that has the X2 interface. The eNBs 20 are connected to the EPC by means of an S1 interface. The eNBs 20 are connected to the MME by means of an S1-MME interface, and are connected to the S-GW by means of S1-U interface. The S1 interface supports a many-to-many relation between the eNB 20 and the MME/S-GW.

FIG. 2 shows a block diagram of architecture of a typical E-UTRAN and a typical EPC. Referring to FIG. 2, the eNB 20 may perform functions of selection for gateway 30, routing toward the gateway 30 during a radio resource control (RRC) activation, scheduling and transmitting of paging messages, scheduling and transmitting of broadcast channel (BCH) information, dynamic allocation of resources to the UEs 10 in both UL and DL, configuration and provisioning of eNB measurements, radio bearer control, radio admission control (RAC), and connection mobility control in LTE_ACTIVE state. In the EPC, and as noted above, gateway 30 may perform functions of paging origination, LTE_IDLE state management, ciphering of the user plane, SAE bearer control, and ciphering and integrity protection of NAS signaling.

FIG. 3 shows a block diagram of a user plane protocol stack and a control plane protocol stack of an LTE system. FIG. 3-(a) shows a block diagram of a user plane protocol stack of an LTE system, and FIG. 3-(b) shows a block diagram of a control plane protocol stack of an LTE system.

Layers of a radio interface protocol between the UE and the E-UTRAN may be classified into a first layer (L1), a second layer (L2), and a third layer (L3) based on the lower three layers of the open system interconnection (OSI) model that is well-known in the communication system. The radio interface protocol between the UE and the E-UTRAN may be horizontally divided into a physical layer, a data link layer, and a network layer, and may be vertically divided into a control plane (C-plane) which is a protocol stack for control signal transmission and a user plane (U-plane) which is a protocol stack for data information transmission. The layers of the radio interface protocol exist in pairs at the UE and the E-UTRAN, and are in charge of data transmission of the Uu interface.

A physical (PHY) layer belongs to the L1. The PHY layer provides a higher layer with an information transfer service through a physical channel. The PHY layer is connected to a medium access control (MAC) layer, which is a higher layer of the PHY layer, through a transport channel. A physical channel is mapped to the transport channel. Data is transferred between the MAC layer and the PHY layer through the transport channel. Between different PHY layers, i.e., a PHY layer of a transmitter and a PHY layer of a receiver, data is transferred through the physical channel using radio resources. The physical channel is modulated using an orthogonal frequency division multiplexing (OFDM) scheme, and utilizes time and frequency as a radio resource.

The PHY layer uses several physical control channels. A physical downlink control channel (PDCCH) reports to a UE about resource allocation of a paging channel (PCH) and a downlink shared channel (DL-SCH), and hybrid automatic repeat request (HARQ) information related to the DL-SCH. The PDCCH may carry a UL grant for reporting to the UE about resource allocation of UL transmission. A physical control format indicator channel (PCFICH) reports the number of OFDM symbols used for PDCCHs to the UE, and is transmitted in every subframe. A physical hybrid ARQ indicator channel (PHICH) carries an HARQ acknowledgement (ACK)/non-acknowledgement (NACK) signal in response to UL transmission. A physical uplink control channel (PUCCH) carries UL control information such as HARQ ACK/NACK for DL transmission, scheduling request, and CQI. A physical uplink shared channel (PUSCH) carries a UL-uplink shared channel (SCH).

FIG. 4 shows an example of a physical channel structure.

A physical channel consists of a plurality of subframes in time domain and a plurality of subcarriers in frequency domain. One subframe consists of a plurality of symbols in the time domain. One subframe consists of a plurality of resource blocks (RBs). One RB consists of a plurality of symbols and a plurality of subcarriers. In addition, each subframe may use specific subcarriers of specific symbols of a corresponding subframe for a PDCCH. For example, a first symbol of the subframe may be used for the PDCCH. The PDCCH carries dynamic allocated resources, such as a physical resource block (PRB) and modulation and coding scheme (MCS). A transmission time interval (TTI) which is a unit time for data transmission may be equal to a length of one subframe. The length of one subframe may be 1 ms.

The transport channel is classified into a common transport channel and a dedicated transport channel according to whether the channel is shared or not. A DL transport channel for transmitting data from the network to the UE includes a broadcast channel (BCH) for transmitting system information, a paging channel (PCH) for transmitting a paging message, a DL-SCH for transmitting user traffic or control signals, etc. The DL-SCH supports HARQ, dynamic link adaptation by varying the modulation, coding and transmit power, and both dynamic and semi-static resource allocation. The DL-SCH also may enable broadcast in the entire cell and the use of beamforming. The system information carries one or more system information blocks. All system information blocks may be transmitted with the same periodicity. Traffic or control signals of a multimedia broadcast/multicast service (MBMS) may be transmitted through the DL-SCH or a multicast channel (MCH).

A UL transport channel for transmitting data from the UE to the network includes a random access channel (RACH) for transmitting an initial control message, a UL-SCH for transmitting user traffic or control signals, etc. The UL-SCH supports HARQ and dynamic link adaptation by varying the transmit power and potentially modulation and coding. The UL-SCH also may enable the use of beamforming. The RACH is normally used for initial access to a cell.

A MAC layer belongs to the L2. The MAC layer provides services to a radio link control (RLC) layer, which is a higher layer of the MAC layer, via a logical channel. The MAC layer provides a function of mapping multiple logical channels to multiple transport channels. The MAC layer also provides a function of logical channel multiplexing by mapping multiple logical channels to a single transport channel. A MAC sublayer provides data transfer services on logical channels.

The logical channels are classified into control channels for transferring control plane information and traffic channels for transferring user plane information, according to a type of transmitted information. That is, a set of logical channel types is defined for different data transfer services offered by the MAC layer. The logical channels are located above the transport channel, and are mapped to the transport channels.

The control channels are used for transfer of control plane information only. The control channels provided by the MAC layer include a broadcast control channel (BCCH), a paging control channel (PCCH), a common control channel (CCCH), a multicast control channel (MCCH) and a dedicated control channel (DCCH). The BCCH is a downlink channel for broadcasting system control information. The PCCH is a downlink channel that transfers paging information and is used when the network does not know the location cell of a UE. The CCCH is used by UEs having no RRC connection with the network. The MCCH is a point-to-multipoint downlink channel used for transmitting MBMS control information from the network to a UE. The DCCH is a point-to-point bi-directional channel used by UEs having an RRC connection that transmits dedicated control information between a UE and the network.

Traffic channels are used for the transfer of user plane information only. The traffic channels provided by the MAC layer include a dedicated traffic channel (DTCH) and a multicast traffic channel (MTCH). The DTCH is a point-to-point channel, dedicated to one UE for the transfer of user information and can exist in both uplink and downlink. The MTCH is a point-to-multipoint downlink channel for transmitting traffic data from the network to the UE.

Uplink connections between logical channels and transport channels include the DCCH that can be mapped to the UL-SCH, the DTCH that can be mapped to the UL-SCH and the CCCH that can be mapped to the UL-SCH. Downlink connections between logical channels and transport channels include the BCCH that can be mapped to the BCH or DL-SCH, the PCCH that can be mapped to the PCH, the DCCH that can be mapped to the DL-SCH, and the DTCH that can be mapped to the DL-SCH, the MCCH that can be mapped to the MCH, and the MTCH that can be mapped to the MCH.

An RLC layer belongs to the L2. The RLC layer provides a function of adjusting a size of data, so as to be suitable for a lower layer to transmit the data, by concatenating and segmenting the data received from a higher layer in a radio section. In addition, to ensure a variety of quality of service (QoS) required by a radio bearer (RB), the RLC layer provides three operation modes, i.e., a transparent mode (TM), an unacknowledged mode (UM), and an acknowledged mode (AM). The AM RLC provides a retransmission function through an automatic repeat request (ARQ) for reliable data transmission. Meanwhile, a function of the RLC layer may be implemented with a functional block inside the MAC layer. In this case, the RLC layer may not exist.

A packet data convergence protocol (PDCP) layer belongs to the L2. The PDCP layer provides a function of header compression function that reduces unnecessary control information such that data being transmitted by employing IP packets, such as IPv4 or IPv6, can be efficiently transmitted over a radio interface that has a relatively small bandwidth. The header compression increases transmission efficiency in the radio section by transmitting only necessary information in a header of the data. In addition, the PDCP layer provides a function of security. The function of security includes ciphering which prevents inspection of third parties, and integrity protection which prevents data manipulation of third parties.

A radio resource control (RRC) layer belongs to the L3. The RLC layer is located at the lowest portion of the L3, and is only defined in the control plane. The RRC layer takes a role of controlling a radio resource between the UE and the network. For this, the UE and the network exchange an RRC message through the RRC layer. The RRC layer controls logical channels, transport channels, and physical channels in relation to the configuration, reconfiguration, and release of RBs. An RB is a logical path provided by the L1 and L2 for data delivery between the UE and the network. That is, the RB signifies a service provided the L2 for data transmission between the UE and E-UTRAN. The configuration of the RB implies a process for specifying a radio protocol layer and channel properties to provide a particular service and for determining respective detailed parameters and operations. The RB is classified into two types, i.e., a signaling RB (SRB) and a data RB (DRB). The SRB is used as a path for transmitting an RRC message in the control plane. The DRB is used as a path for transmitting user data in the user plane.

Referring to FIG. 3-(a), the RLC and MAC layers (terminated in the eNB on the network side) may perform functions such as scheduling, automatic repeat request (ARQ), and hybrid automatic repeat request (HARQ). The PDCP layer (terminated in the eNB on the network side) may perform the user plane functions such as header compression, integrity protection, and ciphering.

Referring to FIG. 3-(b), the RLC and MAC layers (terminated in the eNB on the network side) may perform the same functions for the control plane. The RRC layer (terminated in the eNB on the network side) may perform functions such as broadcasting, paging, RRC connection management, RB control, mobility functions, and UE measurement reporting and controlling. The NAS control protocol (terminated in the MME of gateway on the network side) may perform functions such as a SAE bearer management, authentication, LTE_IDLE mobility handling, paging origination in LTE_IDLE, and security control for the signaling between the gateway and UE.

An RRC state indicates whether an RRC layer of the UE is logically connected to an RRC layer of the E-UTRAN. The RRC state may be divided into two different states such as an RRC connected state and an RRC idle state. When an RRC connection is established between the RRC layer of the UE and the RRC layer of the E-UTRAN, the UE is in RRC_CONNECTED, and otherwise the UE is in RRC_IDLE. Since the UE in RRC_CONNECTED has the RRC connection established with the E-UTRAN, the E-UTRAN may recognize the existence of the UE in RRC_CONNECTED and may effectively control the UE. Meanwhile, the UE in RRC_IDLE may not be recognized by the E-UTRAN, and a CN manages the UE in unit of a TA which is a larger area than a cell. That is, only the existence of the UE in RRC_IDLE is recognized in unit of a large area, and the UE must transition to RRC_CONNECTED to receive a typical mobile communication service such as voice or data communication.

In RRC_IDLE state, the UE may receive broadcasts of system information and paging information while the UE specifies a discontinuous reception (DRX) configured by NAS, and the UE has been allocated an identification (ID) which uniquely identifies the UE in a tracking area and may perform public land mobile network (PLMN) selection and cell re-selection. Also, in RRC_IDLE state, no RRC context is stored in the eNB.

In RRC_CONNECTED state, the UE has an E-UTRAN RRC connection and a context in the E-UTRAN, such that transmitting and/or receiving data to/from the eNB becomes possible. Also, the UE can report channel quality information and feedback information to the eNB. In RRC_CONNECTED state, the E-UTRAN knows the cell to which the UE belongs. Therefore, the network can transmit and/or receive data to/from UE, the network can control mobility (handover and inter-radio access technologies (RAT) cell change order to GSM EDGE radio access network (GERAN) with network assisted cell change (NACC)) of the UE, and the network can perform cell measurements for a neighboring cell.

In RRC_IDLE state, the UE specifies the paging DRX cycle. Specifically, the UE monitors a paging signal at a specific paging occasion of every UE specific paging DRX cycle. The paging occasion is a time interval during which a paging signal is transmitted. The UE has its own paging occasion.

A paging message is transmitted over all cells belonging to the same tracking area. If the UE moves from one TA to another TA, the UE will send a tracking area update (TAU) message to the network to update its location.

When the user initially powers on the UE, the UE first searches for a proper cell and then remains in RRC_IDLE in the cell. When there is a need to establish an RRC connection, the UE which remains in RRC_IDLE establishes the RRC connection with the RRC of the E-UTRAN through an RRC connection procedure and then may transition to RRC_CONNECTED. The UE which remains in RRC_IDLE may need to establish the RRC connection with the E-UTRAN when uplink data transmission is necessary due to a user's call attempt or the like or when there is a need to transmit a response message upon receiving a paging message from the E-UTRAN.

It is known that different cause values may be mapped o the signature sequence used to transmit messages between a UE and eNB and that either channel quality indicator (CQI) or path loss and cause or message size are candidates for inclusion in the initial preamble.

When a UE wishes to access the network and determines a message to be transmitted, the message may be linked to a purpose and a cause value may be determined. The size of the ideal message may be also be determined by identifying all optional information and different alternative sizes, such as by removing optional information, or an alternative scheduling request message may be used.

The UE acquires necessary information for the transmission of the preamble, UL interference, pilot transmit power and required signal-to-noise ratio (SNR) for the preamble detection at the receiver or combinations thereof. This information must allow the calculation of the initial transmit power of the preamble. It is beneficial to transmit the UL message in the vicinity of the preamble from a frequency point of view in order to ensure that the same channel is used for the transmission of the message.

The UE should take into account the UL interference and the UL path loss in order to ensure that the network receives the preamble with a minimum SNR. The UL interference can be determined only in the eNB, and therefore, must be broadcast by the eNB and received by the UE prior to the transmission of the preamble. The UL path loss can be considered to be similar to the DL path loss and can be estimated by the UE from the received RX signal strength when the transmit power of some pilot sequence of the cell is known to the UE.

The required UL SNR for the detection of the preamble would typically depend on the eNB configuration, such as a number of Rx antennas and receiver performance.

There may be advantages to transmit the rather static transmit power of the pilot and the necessary UL SNR separately from the varying UL interference and possibly the power offset required between the preamble and the message.

The initial transmission power of the preamble can be roughly calculated according to the following formula:

Transmit power=TransmitPilot−RxPilot+ULInterference+Offset+SNRRequired

Therefore, any combination of SNRRequired, ULInterference, TransmitPilot and Offset can be broadcast. In principle, only one value must be broadcast. This is essentially in current UMTS systems, although the UL interference in 3GPP LTE will mainly be neighboring cell interference that is probably more constant than in UMTS system.

The UE determines the initial UL transit power for the transmission of the preamble as explained above. The receiver in the eNB is able to estimate the absolute received power as well as the relative received power compared to the interference in the cell. The eNB will consider a preamble detected if the received signal power compared to the interference is above an eNB known threshold.

The UE performs power ramping in order to ensure that a UE can be detected even if the initially estimated transmission power of the preamble is not adequate. Another preamble will most likely be transmitted if no ACK or NACK is received by the UE before the next random access attempt. The transmit power of the preamble can be increased, and/or the preamble can be transmitted on a different UL frequency in order to increase the probability of detection. Therefore, the actual transmit power of the preamble that will be detected does not necessarily correspond to the initial transmit power of the preamble as initially calculated by the UE.

The UE must determine the possible UL transport format. The transport format, which may include MCS and a number of resource blocks that should be used by the UE, depends mainly on two parameters, specifically the SNR at the eNB and the required size of the message to be transmitted.

In practice, a maximum UE message size, or payload, and a required minimum SNR correspond to each transport format. In UMTS, the UE determines before the transmission of the preamble whether a transport format can be chosen for the transmission according to the estimated initial preamble transmit power, the required offset between preamble and the transport block, the maximum allowed or available UE transmit power, a fixed offset and additional margin. The preamble in UMTS need not contain any information regarding the transport format selected by the EU since the network does not need to reserve time and frequency resources and, therefore, the transport format is indicated together with the transmitted message.

The eNB must be aware of the size of the message that the UE intends to transmit and the SNR achievable by the UE in order to select the correct transport format upon reception of the preamble and then reserve the necessary time and frequency resources. Therefore, the eNB cannot estimate the SNR achievable by the EU according to the received preamble because the UE transmit power compared to the maximum allowed or possible UE transmit power is not known to the eNB, given that the UE will most likely consider the measured path loss in the DL or some equivalent measure for the determination of the initial preamble transmission power.

The eNB could calculate a difference between the path loss estimated in the DL compared and the path loss of the UL. However, this calculation is not possible if power ramping is used and the UE transmit power for the preamble does not correspond to the initially calculated UE transmit power. Furthermore, the precision of the actual UE transmit power and the transmit power at which the UE is intended to transmit is very low. Therefore, it has been proposed to code the path loss or CQI estimation of the downlink and the message size or the cause value in the UL in the signature.

Energy saving is under discussion in the 3GPP LTE. For energy saving, deployment scenarios where pico cells are deployed for the purpose of capacity boosting under the coverage of a macro cells have been discussed. For capacity boosting, it is expected that the number of small cells or pico cells with low power are deployed densely.

A method of efficient energy saving is required.

### SUMMARY OF THE INVENTION

The present invention provides a method and apparatus for switching off a cell for energy saving in a wireless communication system. The present invention provides a method for switching of a cell for energy saving while guaranteeing quality of service (QoS) of user equipments (UEs). The present invention provides a method for performing handover of UEs to neighbor cells when an eNodeB (eNB) with which the UEs are connected is switched off.

In an aspect, a method for switching off, by a first eNodeB (eNB), a cell for energy saving in a wireless communication system is provided. The method includes transmitting information on quality of services (QoS) of user equipments (UEs), connected to the first eNB, to a macro eNB, receiving a list of recommended cells for handover of all or a part of the UEs, performing handover of all or the part of the UEs with a second eNB which manages a cell included in the list of recommended cells, and switching off a cell managed by the first eNB.

In another aspect, a method for determining, by a macro eNodeB (eNB), a handover in a wireless communication system is provided. The method includes receiving information on quality of services (QoS) of user equipments (UEs), connected to a first eNB, from the macro eNB, determining which UEs can be accepted by the macro eNB and which UEs cannot be accepted by the macro eNB, and transmitting a list of recommended cells for handover of the UEs which cannot be accepted by the macro eNB.

In another aspect, a first eNodeB (eNB) in a wireless communication system is provided. The first eNB includes a radio frequency (RF) unit for transmitting or receiving a radio signal, and a processor coupled to the RF unit, and configured to transmit information on quality of services (QoS) of user equipments (UEs), connected to the first eNB, to a macro eNB, receive a list of recommended cells for handover of all or a part of the UEs, perform handover of all or the part of the UEs with a second eNB which manages a cell included in the list of recommended cells, and switch off a cell managed by the first eNB.

Cell can be switched off effectively.

### BRIEF DESCRIPTION OF THE DRAWINGS

FIG. 1 shows LTE system architecture.

FIG. 2 shows a block diagram of architecture of a typical E-UTRAN and a typical EPC.

FIG. 3 shows a block diagram of a user plane protocol stack and a control plane protocol stack of an LTE system.

FIG. 4 shows an example of a physical channel structure.

FIGS. 5 and 6 show an intra-MME/S-GW handover procedure.

FIG. 7 shows an overlaid scenario with densely deployed pico cells.

FIG. 8 shows an inter-eNB scenario 1 for energy saving.

FIG. 9 shows an example of a method for switching off a cell according to an embodiment of the present invention.

FIG. 10 shows another example of a method for switching off a cell according to an embodiment of the present invention.

FIG. 11 shows another example of a method for switching off a cell according to an embodiment of the present invention.

FIG. 12 shows a wireless communication system to implement an embodiment of the present invention.

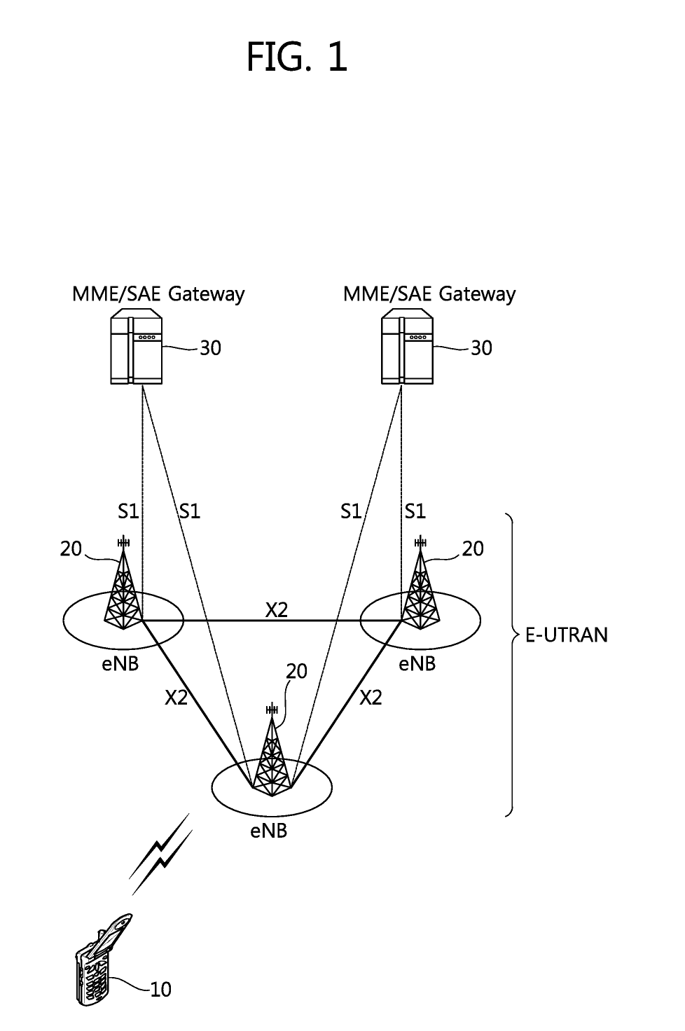

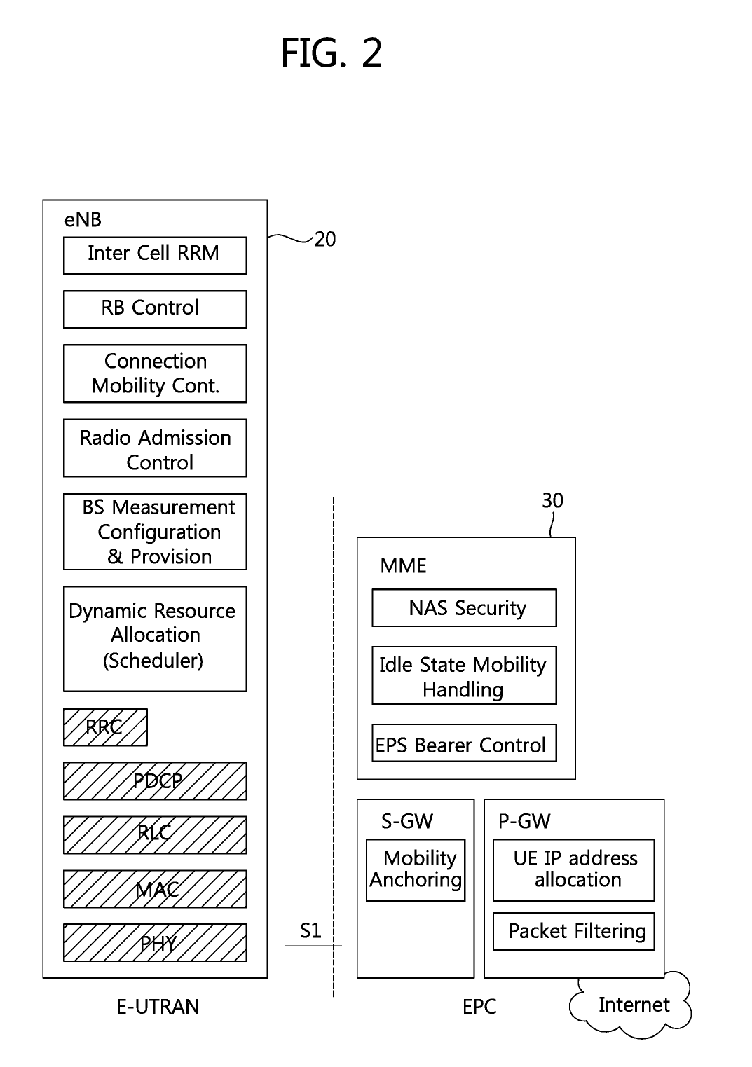

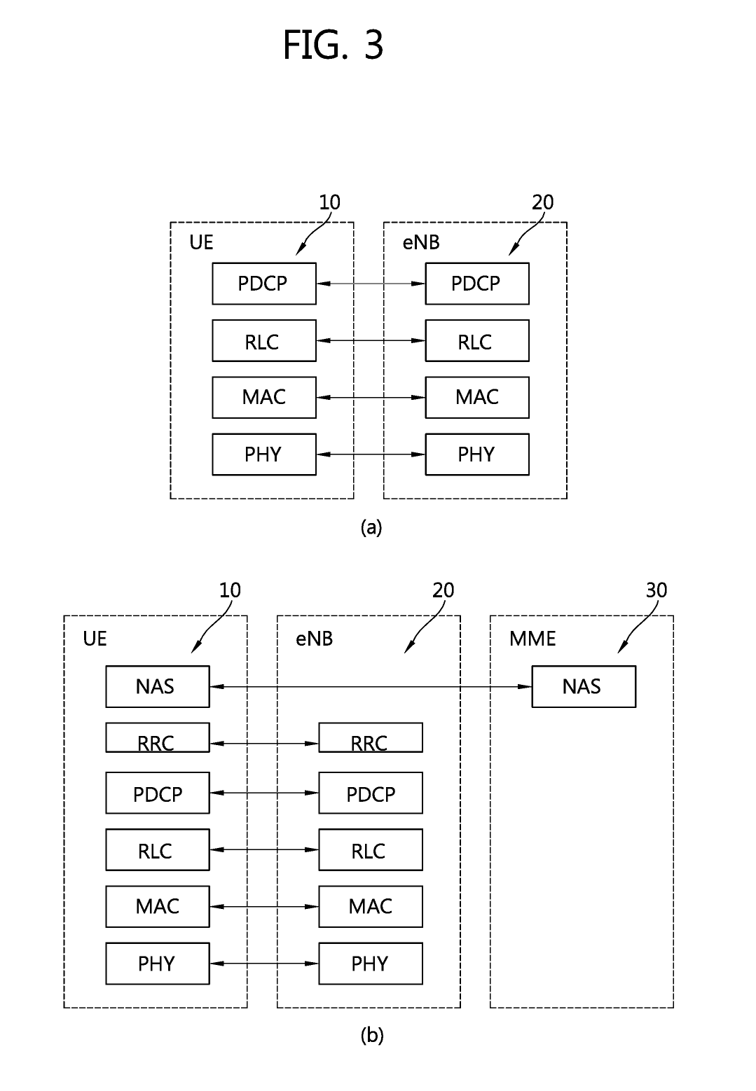

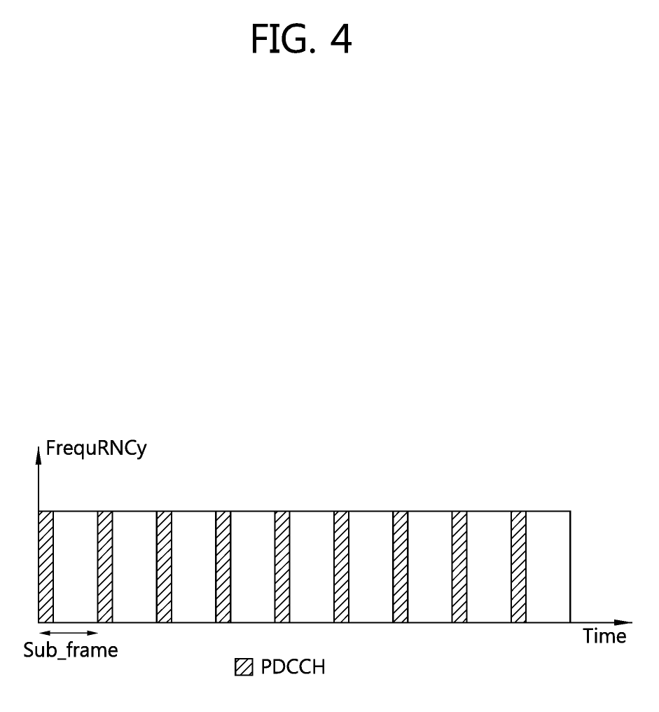

### DESCRIPTION OF EXEMPLARY EMBODIMENTS

The technology described below can be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), etc. The CDMA can be implemented with a radio technology such as universal terrestrial radio access (UTRA) or CDMA-2000. The TDMA can be implemented with a radio technology such as global system for mobile communications (GSM)/general packet ratio service (GPRS)/enhanced data rate for GSM evolution (EDGE). The OFDMA can be implemented with a radio technology such as institute of electrical and electronics engineers (IEEE) 802.11 (Wi-Fi), IEEE 802.16 (WiMAX), IEEE 802-20, evolved UTRA (E-UTRA), etc. IEEE 802.16m is an evolution of IEEE 802.16e, and provides backward compatibility with an IEEE 802.16-based system. The UTRA is a part of a universal mobile telecommunication system (UMTS). 3rd generation partnership project (3GPP) long term evolution (LTE) is a part of an evolved UMTS (E-UMTS) using the E-UTRA. The 3GPP LTE uses the OFDMA in downlink and uses the SC-FDMA in uplink. LTE-advance (LTE-A) is an evolution of the 3GPP LTE.

For clarity, the following description will focus on the LTE-A. However, technical features of the present invention are not limited thereto.

Handover (HO) is described. It may be referred to Section 10.1.2.1 of 3GPP TS 36.300 V11.4.0 (2012-12).

The intra E-UTRAN HO of a UE in RRC_CONNECTED state is a UE-assisted network-controlled HO, with HO preparation signaling in E-UTRAN:
Part of the HO command comes from the target eNB and is transparently forwarded to the UE by the source eNB;
To prepare the HO, the source eNB passes all necessary information to the target eNB (e.g., E-UTRAN radio access bearer (E-RAB) attributes and RRC context): When carrier aggregation (CA) is configured and to enable secondary cell (SCell) selection in the target eNB, the source eNB can provide in decreasing order of radio quality a list of the best cells and optionally measurement result of the cells.
Both the source eNB and UE keep some context (e.g., C-RNTI) to enable the return of the UE in case of HO failure;
UE accesses the target cell via RACH following a contention-free procedure using a dedicated RACH preamble or following a contention-based procedure if dedicated RACH preambles are not available: the UE uses the dedicated preamble until the handover procedure is finished (successfully or unsuccessfully);
If the RACH procedure towards the target cell is not successful within a certain time, the UE initiates radio link failure recovery using the best cell;
No robust header compression (ROHC) context is transferred at handover.

The preparation and execution phase of the HO procedure is performed without EPC involvement, i.e., preparation messages are directly exchanged between the eNBs.

The release of the resources at the source side during the HO completion phase is triggered by the eNB. In case an RN is involved, its donor eNB (DeNB) relays the appropriate S1 messages between the RN and the MME (S1-based handover) and X2 messages between the RN and target eNB (X2-based handover); the DeNB is explicitly aware of a UE attached to the RN due to the S1 proxy and X2 proxy functionality.

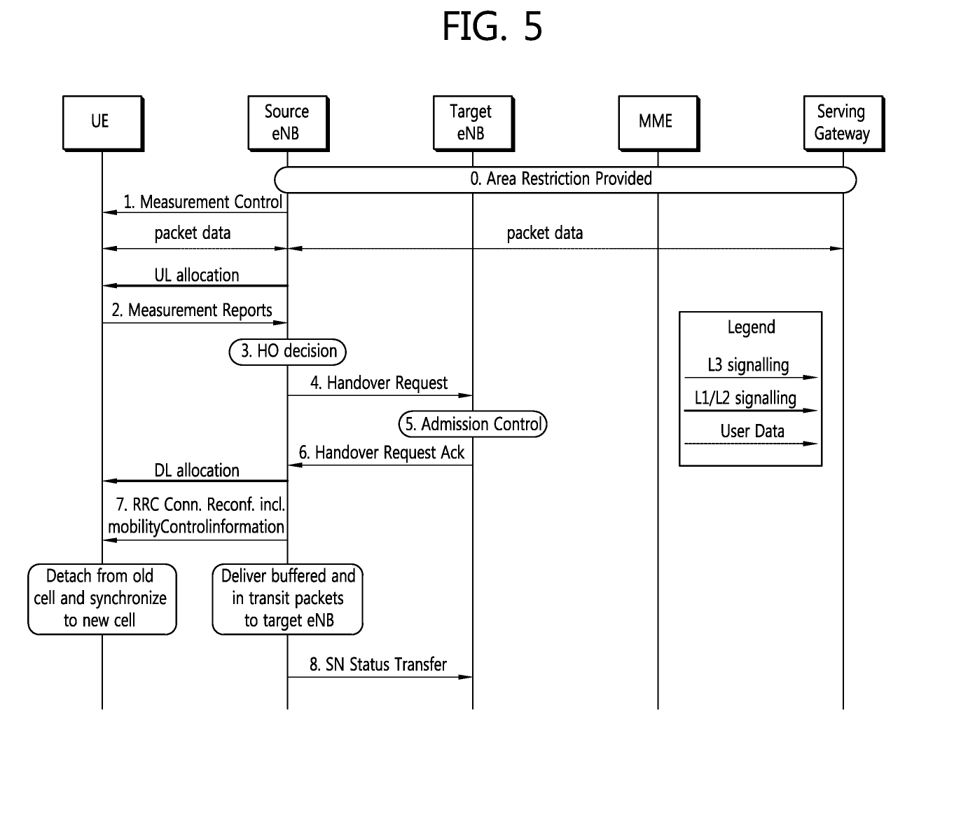

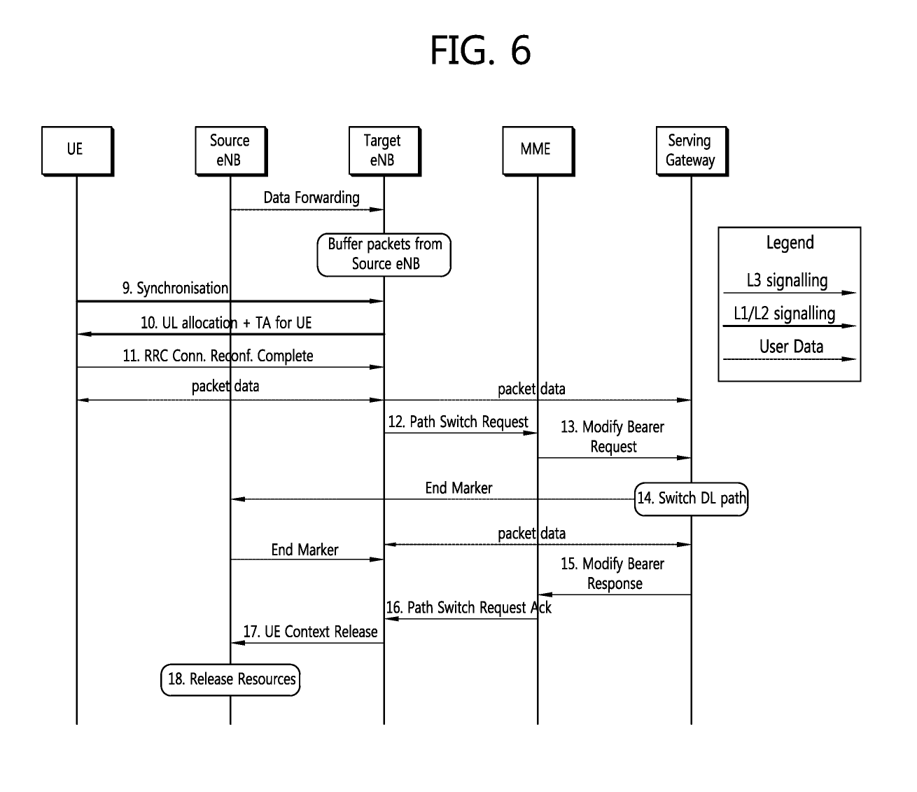

FIGS. 5 and 6 show an intra-MME/S-GW handover procedure.

0. The UE context within the source eNB contains information regarding roaming restrictions which were provided either at connection establishment or at the last TA update.
1. The source eNB configures the UE measurement procedures according to the area restriction information. Measurements provided by the source eNB may assist the function controlling the UE's connection mobility.
2. The UE is triggered to send measurement reports by the rules set by i.e., system information, specification, etc.
3. The source eNB makes decision based on measurement reports and radio resource management (RRM) information to hand off the UE.
4. The source eNB issues a handover request message to the target eNB passing necessary information to prepare the HO at the target side (UE X2 signalling context reference at source eNB, UE S1 EPC signalling context reference, target cell identifier (ID), K_{eNB*}, RRC context including the cell radio network temporary identifier (C-RNTI) of the UE in the source eNB, AS-configuration, E-RAB context and physical layer ID of the source cell+short MAC-I for possible radio link failure (RLF) recovery). UE X2/UE S1 signalling references enable the target eNB to address the source eNB and the EPC. The E-RAB context includes necessary radio network layer (RNL) and transport network layer (TNL) addressing information, and quality of service (QoS) profiles of the E-RABs.
5. Admission Control may be performed by the target eNB dependent on the received E-RAB QoS information to increase the likelihood of a successful HO, if the resources can be granted by target eNB. The target eNB configures the required resources according to the received E-RAB QoS information and reserves a C-RNTI and optionally a RACH preamble. The AS-configuration to be used in the target cell can either be specified independently (i.e., an “establishment”) or as a delta compared to the AS-configuration used in the source cell (i.e., a “reconfiguration”).
6. The target eNB prepares HO with L1/L2 and sends the handover request acknowledge to the source eNB. The handover request acknowledge message includes a transparent container to be sent to the UE as an RRC message to perform the handover. The container includes a new C-RNTI, target eNB security algorithm identifiers for the selected security algorithms, may include a dedicated RACH preamble, and possibly some other parameters, i.e., access parameters, SIBs, etc. The handover request acknowledge message may also include RNL/TNL information for the forwarding tunnels, if necessary.

As soon as the source eNB receives the handover request acknowledge, or as soon as the transmission of the handover command is initiated in the downlink, data forwarding may be initiated.

Steps 7 to 16 in FIGS. 5 and 6 provide means to avoid data loss during HO.

7. The target eNB generates the RRC message to perform the handover, i.e., RRCConnectionReconfiguration message including the mobilityControlInformation, to be sent by the source eNB towards the UE. The source eNB performs the necessary integrity protection and ciphering of the message. The UE receives the RRCConnectionReconfiguration message with necessary parameters (i.e. new C-RNTI, target eNB security algorithm identifiers, and optionally dedicated RACH preamble, target eNB SIBs, etc.) and is commanded by the source eNB to perform the HO. The UE does not need to delay the handover execution for delivering the HARQ/ARQ responses to source eNB.
8. The source eNB sends the sequence number (SN) status transfer message to the target eNB to convey the uplink PDCP SN receiver status and the downlink PDCP SN transmitter status of E-RABs for which PDCP status preservation applies (i.e., for RLC AM). The uplink PDCP SN receiver status includes at least the PDCP SN of the first missing UL service data unit (SDU) and may include a bit map of the receive status of the out of sequence UL SDUs that the UE needs to retransmit in the target cell, if there are any such SDUs. The downlink PDCP SN transmitter status indicates the next PDCP SN that the target eNB shall assign to new SDUs, not having a PDCP SN yet. The source eNB may omit sending this message if none of the E-RABs of the UE shall be treated with PDCP status preservation.
9. After receiving the RRCConnectionReconfiguration message including the mobilityControlInformation, UE performs synchronization to target eNB and accesses the target cell via RACH, following a contention-free procedure if a dedicated RACH preamble was indicated in the mobilityControlInformation, or following a contention-based procedure if no dedicated preamble was indicated. UE derives target eNB specific keys and configures the selected security algorithms to be used in the target cell.
10. The target eNB responds with UL allocation and timing advance.
11. When the UE has successfully accessed the target cell, the UE sends the RRCConnectionReconfigurationComplete message (C-RNTI) to confirm the handover, along with an uplink buffer status report, whenever possible, to the target eNB to indicate that the handover procedure is completed for the UE. The target eNB verifies the C-RNTI sent in the RRCConnectionReconfigurationComplete message. The target eNB can now begin sending data to the UE.
12. The target eNB sends a path switch request message to MME to inform that the UE has changed cell.
13. The MME sends a modify bearer request message to the serving gateway.
14. The serving gateway switches the downlink data path to the target side. The Serving gateway sends one or more “end marker” packets on the old path to the source eNB and then can release any U-plane/TNL resources towards the source eNB.
15. The serving gateway sends a modify bearer response message to MME.
16. The MME confirms the path switch request message with the path switch request acknowledge message.
17. By sending the UE context release message, the target eNB informs success of HO to source eNB and triggers the release of resources by the source eNB. The target eNB sends this message after the path switch request acknowledge message is received from the MME.
18. Upon reception of the UE context release message, the source eNB can release radio and C-plane related resources associated to the UE context. Any ongoing data forwarding may continue.

The handover request message is sent by the source eNB to the target eNB to request the preparation of resources for a handover. It may be referred to Section 9.1.1.1 of 3GPP TS 36.423 V11.4.0 (2013-03). Table 1 shows the handover request message.

TABLE 1

| | | | | IE type and | Semantics | | Assigned |
|---|---|---|---|---|---|---|---|
| IE/Group Name | | Presence | Range | reference | description | Criticality | Criticality |
| Message Type | | M | | 9.2.13 | | YES | reject |
| Old eNB UE X2AP | | M | | eNB UE | Allocated at | YES | reject |
| ID | | | | X2AP | the source | | |
| | | | | ID | eNB | | |
| | | | | 9.2.24 | | | |
| Cause | | M | | 9.2.6 | | YES | ignore |
| Target Cell ID | | M | | ECGI | | YES | reject |
| | | | | 9.2.14 | | | |
| GUMMEI | | M | | 9.2.16 | | YES | reject |
| UE Context | | | 1 | | | YES | reject |
| Information | | | | | | | |
| >MME UE S1AP | | M | | INTEGER | MME UE | — | — |
| ID | | | | (0 . . . | S1AP ID | | |
| | | | | 2³² −1) | allocated at | | |
| | | | | | the MME | | |
| >UE Security | | M | | 9.2.29 | | — | — |
| Capabilities | | | | | | | |
| >AS Security | | M | | 9.2.30 | | — | — |
| Information | | | | | | | |
| >UE Aggregate | | M | | 9.2.12 | | — | — |
| Maximum Bit Rate | | | | | | | |
| >Subscriber Profile | | O | | 9.2.25 | | — | — |
| ID for | | | | | | | |
| RAT/Frequency | | | | | | | |
| priority | | | | | | | |
| >E-RABs To Be | | | 1 | | | — | — |
| Setup List | | | | | | | |
| | >>E-RABs To | | 1 . . . | | | EACH | ignore |
| | Be Setup Item | | <maxnoof | | | | |
| | | | Bearers> | | | | |
| | >>>E-RAB ID | M | | 9.2.23 | | — | — |
| | >>>E-RAB | M | | 9.2.9 | Includes | — | — |
| | Level QoS | | | | necessary | | |
| | Parameters | | | | QoS | | |
| | | | | | parameters | | |
| | >>>DL | O | | 9.2.5 | | — | — |
| | Forwarding | | | | | | |
| | >>>UL GTP | M | | GTP | SGW | — | — |
| | Tunnel | | | Tunnel | endpoint of | | |
| | Endpoint | | | Endpoint | the S1 | | |

| | | | | | |
|---|---|---|---|---|---|
| | | 9.2.1 | transport | | |
| | | | bearer. For | | |
| | | | delivery of | | |
| | | | UL PDUs. | | |
| >RRC Context | M | OCTET | Includes the | — | — |
| | | STRING | RRC | | |
| | | | Handover | | |
| | | | Preparation | | |
| | | | Information | | |
| | | | message as | | |
| | | | defined in | | |
| | | | subclause | | |
| | | | 10.2.2 of TS | | |
| | | | 36.331 [9] | | |
| >Handover | O | 9.2.3 | | — | — |
| Restriction List | | | | | |
| >Location | O | 9.2.21 | Includes the | — | — |
| Reporting | | | necessary | | |
| Information | | | parameters | | |
| | | | for location | | |
| | | | reporting | | |
| >Management | O | 9.2.59 | | YES | ignore |
| Based MDT | | | | | |
| Allowed | | | | | |
| >Management | O | MDT | | YES | ignore |
| Based MDT | | PLMN | | | |
| PLMN List | | List | | | |
| | | 9.2.64 | | | |
| UE History | M | 9.2.38 | Same | YES | ignore |
| Information | | | definition as | | |
| | | | in TS 36.413 | | |
| | | | [4] | | |
| Trace Activation | O | 9.2.2 | | YES | ignore |
| SRVCC Operation | O | 9.2.33 | | YES | ignore |
| Possible | | | | | |
| CSG Membership | O | 9.2.52 | | YES | reject |
| Status | | | | | |
| Mobility | O | BIT | Information | YES | ignore |
| Information | | STRING | related to the | | |
| | | (SIZE | handover; the | | |
| | | (32)) | source eNB | | |
| | | | provides it in | | |
| | | | order to | | |
| | | | enable later | | |
| | | | analysis of | | |
| | | | the conditions | | |
| | | | that led to a | | |
| | | | wrong HO. | | |

Referring to Table 1, the cause information element (IE) is included in the handover request message. The purpose of the cause IE is to indicate the reason for a particular event for the whole protocol. It may be referred to Section 9.2.6 of 3GPP TS 36.423 V11.4.0 (2013-03). Table 2 shows the cause IE.

TABLE 2

| | | | IE Type and | Semantics |
|---|---|---|---|---|
| IE/Group Name | Presence | Range | Reference | Description |
| CHOICE Cause Group | M | | | |
| >Radio Network Layer | | | | |
| >>Radio Network | M | | ENUMERATED | |
| Layer Cause | | | (Handover Desirable for | |
| | | | Radio Reasons, | |
| | | | Time Critical Handover, | |
| | | | Resource Optimisation | |
| | | | Handover, | |
| | | | Reduce Load in Serving Cell, | |
| | | | Partial Handover, | |
| | | | Unknown New eNB UE | |
| | | | X2AP ID, Unknown Old | |
| | | | eNB UE X2AP ID, | |
| | | | Unknown Pair of UE X2AP | |
| | | | ID, | |
| | | | HO Target not Allowed, | |
| | | | TX2_{RELOCoverall} Expiry, | |
| | | | T_{RELOCprep} Expiry, | |
| | | | Cell not Available, | |
| | | | No Radio Resources | |
| | | | Available in Target Cell, | |
| | | | Invalid MME Group ID, | |
| | | | Unknown MME Code, | |
| | | | Encryption And/Or Integrity | |
| | | | Protection Algorithms Not | |
| | | | Supported, | |
| | | | ReportCharacteristicsEmpty, | |
| | | | NoReportPeriodicity, | |
| | | | ExistingMeasurementlD, | |
| | | | Unknown eNB Measurement | |
| | | | ID, Measurement | |
| | | | Temporarily not Available, | |
| | | | Unspecified, | |
| | | | . . ., | |
| | | | Load Balancing, Handover | |
| | | | Optimisation, Value out of | |
| | | | allowed range, Multiple E- | |
| | | | RAB ID instances, Switch | |
| | | | Off Ongoing, Not supported | |
| | | | QCI value, Measurement not | |
| | | | supported for the object) | |
| >Transport Layer | | | | |
| >>Transport Layer | M | | ENUMERATED | |
| Cause | | | (Transport Resource | |
| | | | Unavailable, | |
| | | | Unspecified, | |
| | | | . . .) | |
| >Protocol | | | | |
| >>Protocol Cause | M | | ENUMERATED | |
| | | | (Transfer Syntax Error, | |
| | | | Abstract Syntax Error | |
| | | | (Reject), | |
| | | | Abstract Syntax Error | |
| | | | (Ignore and Notify), | |
| | | | Message not Compatible | |
| | | | with Receiver State, | |
| | | | Semantic Error, | |
| | | | Unspecified, | |
| | | | Abstract Syntax Error | |
| | | | (Falsely Constructed | |
| | | | Message), . . .) | |
| >Misc | | | | |
| >>Miscellaneous | M | | ENUMERATED | |
| Cause | | | (Control Processing | |
| | | | Overload, | |
| | | | Hardware Failure, | |
| | | | O&M Intervention, | |
| | | | Not enough User Plane | |
| | | | Processing Resources, | |
| | | | Unspecified, . . .) | |

Inter-eNodeB (eNB) energy saving is described. It may be referred to Section 6 of 3GPP TR 36.927 V11.0.0 (2012-09).

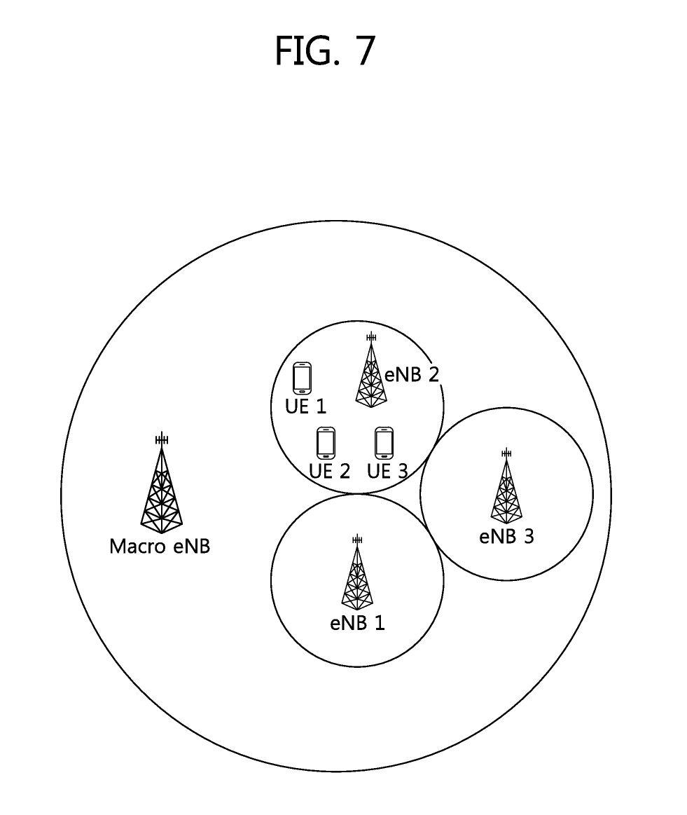

FIG. 7 shows an overlaid scenario with densely deployed pico cells. Energy saving in overlaid scenario is under discussion in the 3GPP LTE. In this discussion, deployment scenarios where pico cells are deployed for the purpose of capacity boosting under the coverage of a macro cells are discussed. It is expected that the number of small cells or pico cells with low power are deployed. Referring to FIG. 7, in coverage of a macro eNB, eNB1, eNB2, and eNB3, which serve pico cells respectively, are densely deployed.

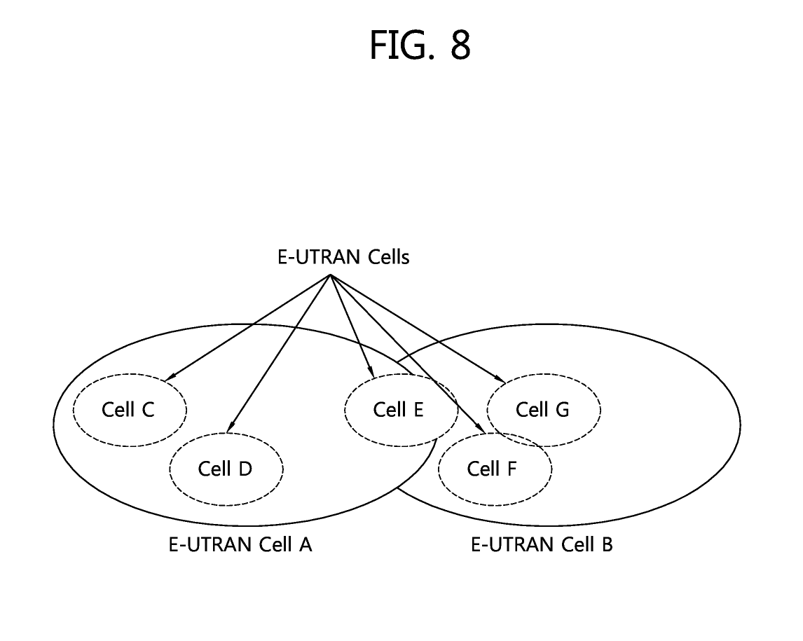

FIG. 8 shows an inter-eNB scenario 1 for energy saving. The inter-eNB scenario 1 for energy saving may be called an overlaid coverage scenario. Referring to FIG. 8, E-UTRAN cell C, D, E, F and G are covered by the E-UTRAN cell A and B. Here, E-UTRAN cell A and B have been deployed to provide basic coverage, while the other E-UTRAN cells boost the capacity. E-UTRAN cells which provide basic coverage may be called a coverage cell, and E-UTRAN cells which boost the capacity may be called a capacity booster cell. When some cells providing additional capacity are no longer needed, they may be switched off for energy optimization. In this case, both the continuity of LTE coverage and service quality of service (QoS) is guaranteed. If all cells have the same multiple public land mobile networks (PLMNs) in a network sharing scenario, there are no issues with the solutions to the overlaid coverage scenario. In general, inter-eNB energy saving mechanisms should preserve the basic coverage in the network by E-UTRAN cells A and B, while pico cells such as E-UTRAN cells C, D, E, F, and G can be switched off for energy saving purpose.

As described above in Table 1, in the handover request message, the cause value may indicate that this handover is for the purpose of energy saving. And, various methods are under discussion in order to provide UE's QoS when an energy saving cell switches off for energy saving. For one of methods for providing QoS for UEs, non guaranteed bit rate (GBR) data rate requirements may be included in the handover request messages. Or, for another method for providing QoS for UEs, UE-AMBR or list of E-RAB may be used before initiating each UE's handover for energy saving purpose. In both methods, the basic coverage is provided by the macro cell, therefore the energy saving cell handovers all UEs that are connected to the energy saving cell to the macro cell. Using these schemes, the energy saving cell cannot be switched off if all UEs connected to the energy saving cell cannot be handed over to the macro cell.

However, when the pico cells are densely deployed as described in FIG. 7, it is possible that an UE connected to a pico eNB can be handed over to another pico eNB instead of the macro eNB, if the another eNB cell can provide Qos for the UE. For example, in FIG. 7, it is possible that an UE that is connected to the eNB2 can be handed over to the eNB1 instead of the macro eNB if the eNB1 can provide QoS to that UE, while other UEs are handed over to the macro eNB. Currently, distributed handover to more than one eNB is not supported. So, there can be cases where the pico eNB cannot be switched off even though there is a way that it can be switched off if all UEs handover connected to the pico eNB to appropriate cells.

Therefore, a method for switching off a cell for energy saving by highly utilizing neighbor cells may be proposed according to an embodiment of the present invention. According to an embodiment of the present invention, when an eNB is switched off in a situation that pico cells are densely deployed, UEs connected to the eNB can be handed over to neighbor cells effectively, instead of the macro cell. Accordingly, Qos for UEs can be guaranteed, and cell switching off for energy saving can be performed effectively.

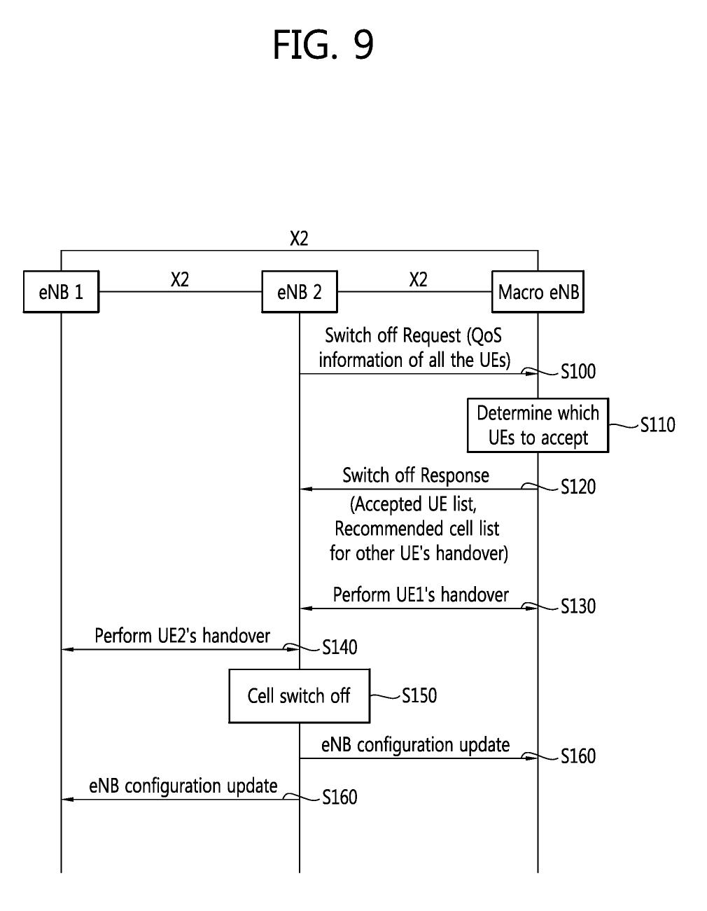

FIG. 9 shows an example of a method for switching off a cell according to an embodiment of the present invention. FIG. 9 corresponds to a case that the macro eNB recommends the other cell for handover of UEs before initiating a handover procedure.

In step S100, the eNB2, which intends to switch off its cell for energy saving, transmits a switch off request message to the macro eNB, before performing handover of UEs connected to the eNB2. The switch off request message may include information on UEs connected to the eNB2 in order to handover UEs connected to the eNB2 to another cell. The information on UEs may include QoS information of UEs. The QoS information may be one of a summation of AMBR of UEs, E-RAB list of UEs, or minimum data rate required for each UE.

In step S110, upon receiving the switch off request message, the macro eNB determines which UEs connected to the eNB2 can be accepted by the macro eNB. That is, the macro eNB distinguishes UEs which can be accepted by the macro eNB and UEs which cannot be accepted by the macro eNB, and determines whether other cell can accept UEs which cannot be accepted by the macro eNB or not. It is assumed that the macro eNB knows load information of pico cells in coverage of the macro cell by e.g., a radio status update message. The macro eNB may determine which UEs can be accepted by the macro eNB and which UEs cannot be accepted by the macro eNB by the load information.

In step 120, the macro eNB transmits a switch off response message to the eNB2. The switch off response message may include accepted UE list, and recommended cell list for other UE's handover. That is, if the macro eNB determines that the other cell can accept UEs which cannot be accepted by the macro eNB, the macro eNB may indicate handover of corresponding UEs to the other cell. In this embodiment, it is assumed that the other cell is a cell managed by the eNB1.

In step S130, the eNB2 performs handover of UE1, which is accepted by the macro eNB, with the macro eNB according to the information included in the switch off response message. In step S140, the eNB2 performs handover of UE2, which is not accepted by the macro eNB, with the eNB1 according to the information included in the switch off response message. After completing handover of all UEs connected to the eNB2, in step S150, the eNB2 switched off its cell. In step S160, the eNB2 transmits an eNB configuration update message to the macro eNB and eNB1 to inform that the cell of the eNB2 is switched off for energy saving.

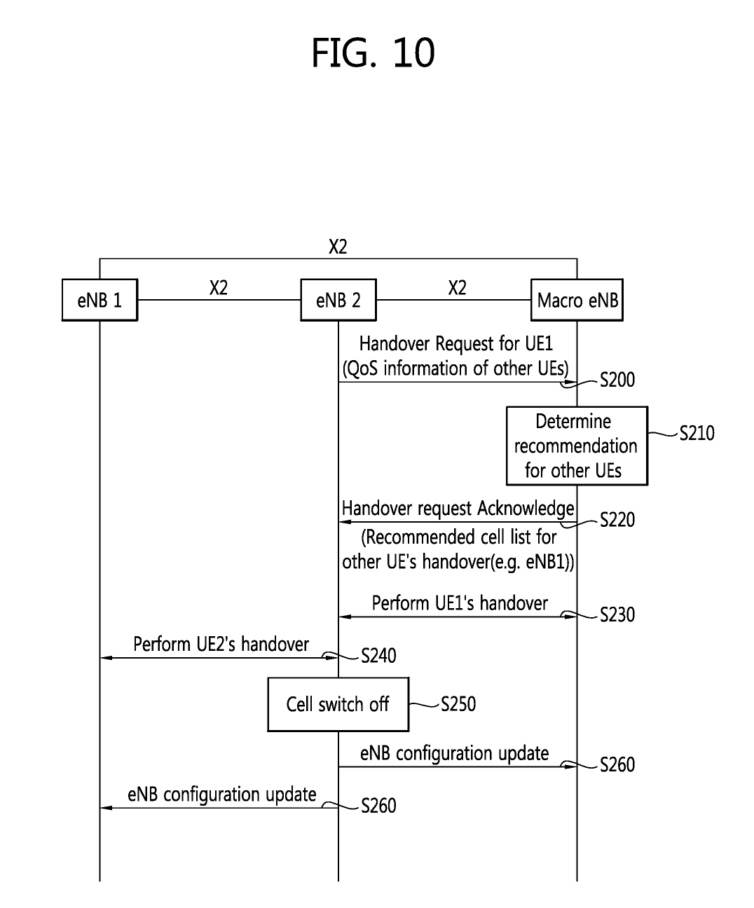

FIG. 10 shows another example of a method for switching off a cell according to an embodiment of the present invention. FIG. 10 corresponds to a case that the macro eNB recommends the other cell for handover of UEs during a handover preparation procedure.

In step S200, the eNB2, which intends to switch off its cell for energy saving, transmits a handover request message for handover of the UE1 to the macro eNB. That is, switch off request of the eNB2 may be included in the handover request message when the eNB2 requests handover of the UE1. The handover request message may include information on other UEs connected to the eNB2 in order to handover UEs connected to the eNB2 to another cell. The information on UEs may include QoS information of other UEs. The QoS information may be one of a summation of AMBR of UEs, E-RAB list of UEs, or minimum data rate required for each UE.

In step S210, upon receiving the handover request message, the macro eNB determines recommendation for other UEs. It is assumed that the UE1 is accepted by the macro eNB. The macro eNB determines whether other cell can accept other UEs than the UE1 or not. It is assumed that the macro eNB knows load information of pico cells in coverage of the macro cell by e.g., a radio status update message. The macro eNB may determine which UEs can be accepted by the macro eNB and which UEs cannot be accepted by the macro eNB by the load information.

In step S220, the macro eNB transmits a handover request acknowledge message to the eNB2. The handover request acknowledge message may include recommended cell list for other UE's handover. That is, if the macro eNB determines that the other cell can accept other UEs, the macro eNB may indicate handover of corresponding UEs to the other cell. In this embodiment, it is assumed that the other cell is a cell managed by the eNB1.

In step S230, the eNB2 performs handover of the UE1 with the macro eNB according to the information included in the handover request acknowledge message. In step S240, the eNB2 performs handover of other UEs with the eNB1 according to the information included in the handover request acknowledge message. After completing handover of all UEs connected to the eNB2, in step S250, the eNB2 switched off its cell. In step S260, the eNB2 transmits an eNB configuration update message to the macro eNB and eNB1 to inform that the cell of the eNB2 is switched off for energy saving.

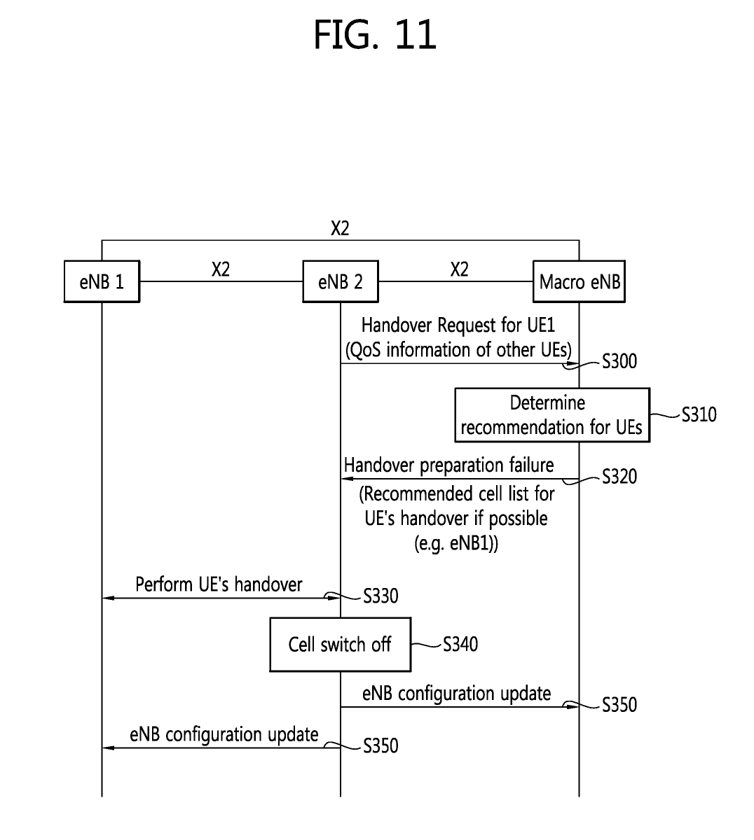

FIG. 11 shows another example of a method for switching off a cell according to an embodiment of the present invention. FIG. 11 corresponds to a case that the macro eNB recommends the other cell for handover of UEs during a handover preparation failure.

In step S300, the eNB2, which intends to switch off its cell for energy saving, transmits a handover request message for handover of the UE1 to the macro eNB. That is, switch off request of the eNB2 may be included in the handover request message when the eNB2 requests handover of the UE1. The handover request message may include information on other UEs connected to the eNB2 in order to handover UEs connected to the eNB2 to another cell. The information on UEs may include QoS information of other UEs. The QoS information may be one of a summation of AMBR of UEs, E-RAB list of UEs, or minimum data rate required for each UE.

In step S310, upon receiving the handover request message, the macro eNB determines recommendation for UEs. It is assumed that the UE1 is not accepted by the macro eNB. The macro eNB determines whether other cell can accept UEs, connected to the eNB2, or not. It is assumed that the macro eNB knows load information of pico cells in coverage of the macro cell by e.g., a radio status update message. The macro eNB may determine which UEs can be accepted by the macro eNB and which UEs cannot be accepted by the macro eNB by the load information.

In step S320, the macro eNB transmits a handover preparation failure message to the eNB2. The handover preparation failure message may include recommended cell list for UE's handover if possible. That is, if the macro eNB determines that the other cell can accept UEs connected to the eNB2, the macro eNB may indicate handover of corresponding UEs to the other cell. In this embodiment, it is assumed that the other cell is a cell managed by the eNB1.

In step S330, the eNB2 performs handover of UEs with the eNB1 according to the information included in the handover request acknowledge message. After completing handover of all UEs connected to the eNB2, in step S340, the eNB2 switched off its cell. In step S350, the eNB2 transmits an eNB configuration update message to the macro eNB and eNB1 to inform that the cell of the eNB2 is switched off for energy saving.

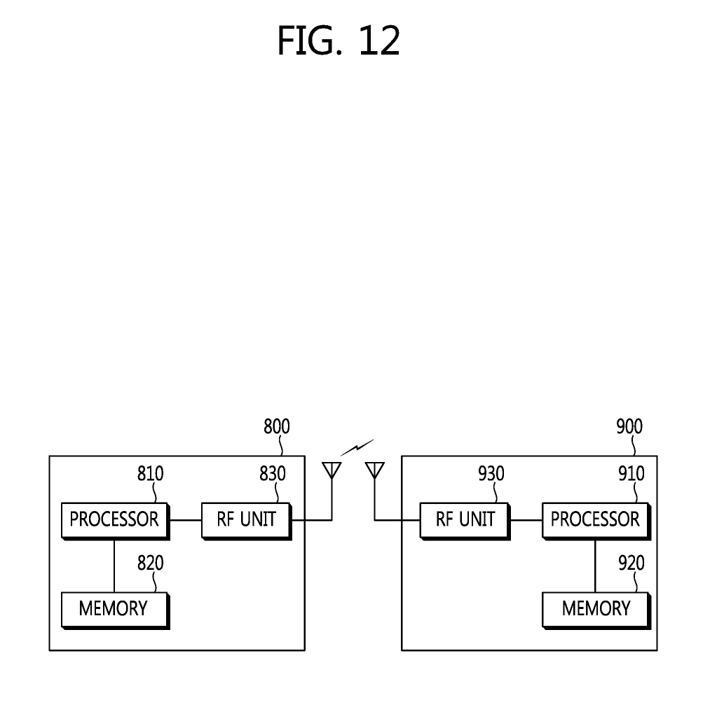

FIG. 12 shows a wireless communication system to implement an embodiment of the present invention.

A first eNB 800 includes a processor 810, a memory 820, and a radio frequency (RF) unit 830. The processor 810 may be configured to implement proposed functions, procedures, and/or methods in this description. Layers of the radio interface protocol may be implemented in the processor 810. The memory 820 is operatively coupled with the processor 810 and stores a variety of information to operate the processor 810. The RF unit 830 is operatively coupled with the processor 810, and transmits and/or receives a radio signal.

A second eNB 900 includes a processor 910, a memory 920 and an RF unit 930. The processor 910 may be configured to implement proposed functions, procedures and/or methods described in this description. Layers of the radio interface protocol may be implemented in the processor 910. The memory 920 is operatively coupled with the processor 910 and stores a variety of information to operate the processor 910. The RF unit 930 is operatively coupled with the processor 910, and transmits and/or receives a radio signal.

The processors 810, 910 may include application-specific integrated circuit (ASIC), other chipset, logic circuit and/or data processing device. The memories 820, 920 may include read-only memory (ROM), random access memory (RAM), flash memory, memory card, storage medium and/or other storage device. The RF units 830, 930 may include baseband circuitry to process radio frequency signals. When the embodiments are implemented in software, the techniques described herein can be implemented with modules (e.g., procedures, functions, and so on) that perform the functions described herein. The modules can be stored in memories 820, 920 and executed by processors 810, 910. The memories 820, 920 can be implemented within the processors 810, 910 or external to the processors 810, 910 in which case those can be communicatively coupled to the processors 810, 910 via various means as is known in the art.

According to the embodiment of the present invention, a cell may be switched off for energy saving effectively by handing over UEs to at least two cells even though one cell (e.g., macro cell) cannot support coverage. Further, a case that a cell cannot be switched off for energy saving since a part of UEs, connected to the cell, cannot be handed over can be avoided.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

What is claimed is:

1. A method for switching off, by a first eNodeB (eNB), a cell for energy saving in a wireless communication system, the method comprising:
transmitting information on quality of services (QoS) of user equipments (UEs), connected to the first eNB, to a macro eNB;
receiving a list of recommended cells for handover of all or a part of the UEs;
performing handover of all or the part of the UEs with a second eNB which manages a cell included in the list of recommended cells; and
switching off a cell managed by the first eNB.

2. The method of claim 1, wherein the information on QoS of the UEs includes at least one of summation of aggregate maximum bit rate (AMBR) of the UEs, E-UTRAN radio access bearer (E-RAB) list of the UEs, or minimum data rate required for each UE.

3. The method of claim 1, wherein the information on QoS of the UEs is transmitted via a switch off request message before initiating a handover procedure.

4. The method of claim 3, wherein the list of recommended cells is received via a switch off response message which is a response to the switch off request message.

5. The method of claim 1, wherein the information on QoS of the UEs is transmitted via a handover request message during a handover procedure.

6. The method of claim 5, wherein the list of recommended cells is received via a handover request acknowledge message which is a response to the handover request message.

7. The method of claim 5, wherein the list of recommended cells is received via a handover preparation failure message which is a response to the handover request message.

8. The method of claim 1, wherein all or the part of the UEs are UEs which are not accepted by the macro eNB.

9. The method of claim 1, further comprising:
receiving a list of UEs which are accepted by the macro eNB together with the list of recommended cells.

10. The method of claim 8, further comprising:
performing handover of UEs, which are accepted by the macro eNB, with the macro eNB.

11. The method of claim 1, further comprising:
transmitting an eNB configuration update message to the second eNB and the macro eNB.

12. The method of claim 1, wherein the first eNB and the second eNB are pico eNBs whose cells are densely deployed.

13. A method for determining, by a macro eNodeB (eNB), a handover in a wireless communication system, the method comprising:
receiving information on quality of services (QoS) of user equipments (UEs), connected to a first eNB, from the macro eNB;
determining which UEs can be accepted by the macro eNB and which UEs cannot be accepted by the macro eNB; and
transmitting a list of recommended cells for handover of the UEs which cannot be accepted by the macro eNB.

14. A first eNodeB (eNB) in a wireless communication system, the first eNB comprising:
a radio frequency (RF) unit for transmitting or receiving a radio signal; and
a processor coupled to the RF unit, and configured to:
transmit information on quality of services (QoS) of user equipments (UEs), connected to the first eNB, to a macro eNB;
receive a list of recommended cells for handover of all or a part of the UEs;
perform handover of all or the part of the UEs with a second eNB which manages a cell included in the list of recommended cells; and
switch off a cell managed by the first eNB.
